(19) United States
(12) Patent Application Publication
(10) Pub. No.: US 2015/0347649 A1
(43) Pub. Date: Dec. 3, 2015

(54) SOLUTION SEARCH DEVICE, SOLUTION SEARCH METHOD, AND SOLUTION SEARCH PROGRAM

(71) Applicant: NEC Corporation, Tokyo (JP)

(72) Inventor: Takashi SHIRAKI, Tokyo (JP)

(21) Appl. No.: 14/759,598

(22) PCT Filed: Dec. 27, 2013
(86) PCT No.: PCT/JP2013/007673

§ 371 Date: Jul. 7, 2015

(30) Foreign Application Priority Data
Jan. 25, 2013 (JP) 2013-011628

(51) Int. Cl. G06F 17/50; G06F 17/18

(52) U.S. Cl. CPC G06F 17/5009; G06F 17/18

(57) ABSTRACT

To provide a solution search device, a solution search method, and a solution search program capable of accurately calculating a solution within a designated calculation time and enhancing an accuracy of solution without increasing the amount of memory use when solving an optimization problem. The solution search device includes an execution unit 101 for selecting a node to be simulated from among nodes as options in a search tree in solution search using simulation, and performing a simulation from the selected node, an update unit 102 for calculating an evaluation value by use of an evaluation function based on a simulation result, and updating evaluation values of the selected node and its higher nodes based on the evaluation value, and a pruning unit 103 for separating a node with an evaluation value which does not meet a predefined standard from the search tree.

### TECHNICAL FIELD

The present invention relates to a solution search device, a solution search method, and a solution search program applied for searching a solution in optimization calculation or the like.

### BACKGROUND ART

An optimization problem is a problem for which a target function and a restriction condition are set and an optimum solution is derived for the best target function in many cases. A search method using a simulation such as MCTS (Monte-Carlo Tree Search) described in Non-Patent Literature 1 is paid attention in the field of artificial intelligence. The search method is regarded as an advanced method for solving MBP (Multi-armed bandit Problem) attracting attention in the field of data mining or machine learning. The search method is being put into practical use, and an example of its successfully practical use is computer go. Practical use of the search method is expected in optimization used in OR (Operations Research) or the like, but it is difficult to realize.

The most striking difference between computer go and optimization is that for a tree of solution space (which will be called solution space tree below), the best node is to be searched in a next level in the levels of the solution space tree in computer go while the best node is to be searched from among the solution nodes in the lowest level in optimization. It is an unprecedented object in MCTS to extend the search tree down to the lowest level of the solution space tree.

The techniques important for MCTS are a method for setting an evaluation function for each node using a simulation result and a method for performing a simulation called playout. An evaluation function used for computer go is based on UCB (Upper Confidence Bound) described in Non-Patent Literature 2. The evaluation function used for computer go employs an expectation-based value. The expectation is a winning rate or the like of go. However, the evaluation function is better off using a solution or k solutions better or higher than the expectation, or an average of the best k solutions (see Non-Patent Literature 3). That is, it is important for computer go to appropriately select and use the evaluation functions. In the following, an expectation-based evaluation function will be denoted as mean, an optimum solution-based evaluation function will be denoted as best, and an evaluation function based on an average of the highest k solutions will be denoted as kbest.

Which to use best or kbest depends on an optimization target, and cannot be uniquely defined. That is, it is important to appropriately select which evaluation function to use.

### CITATION LIST

### Patent Literature

NPL 1: C. Browne, E. Powley, D. Whitehouse, S. Lucas, P. I. Cowling, P. Rohlfshagen, S. Travener, D. Perez, S. Samothrakis and S. Colton, A Survey of Monte Carlo Tree Search Methods, IEEE Transactions on Computational Intelligence and AI in Games, Vol, 4, No. 1, March 2012.
NPL 2: P. Auer, N. Cesa-Bianchi, and P. Fischer, Finite-time Analysis of the Multiarmed Bandit Problem, Machine Learning, Vol. 47, p. 235-256, 2002
NPL 3: A. Rimmel, F. Teytaud, and T. Cazenave, “Optimization of the nested Monte-Carlo algorithm on the traveling salesman problem with time windows,” in Proc. Appl. Evol. Comput. 2, Torino, Italy, 2011, pp. 501-510

### SUMMARY OF INVENTION

### Technical Problem

For a big solution space tree, when a search tree is enlarged from the initial calculation, the number of nodes to be held increases. At this time, when a standard for enlargement is lowered, a memory capacity can be exceeded. When the standard for enlargement is raised, a solution node at the bottom of the solution space tree cannot be reached even if a large amount of calculation time is spent.

For optimization calculation, generally a time to acquire a solution is previously designated by a user or the like. In order to successfully perform MCTS by optimization, an accuracy of solution cannot be enhanced unless the search tree reaches the bottom of the solution space tree until the designated time. That is, in order to enhance the accuracy of solution, the search tree needs to accurately reach the bottom of the solution space tree until the designated time.

It is therefore an object of the present invention is to provide a solution search device, a solution search method, and a solution search program capable of accurately calculating a solution within a designated calculation time and enhancing an accuracy of solution without increasing the amount of memory use when solving an optimization problem.

### Solution to Problem

A solution search device according to the present invention includes an execution unit for selecting a node to be simulated from among nodes as options in a search tree in solution search using simulation, and performing a simulation from the selected node, an update unit for calculating an evaluation value by use of an evaluation function based on a simulation result, and updating evaluation values of the selected node and its higher nodes based on the evaluation value, and a pruning unit for separating a node with an evaluation value which does not meet a predefined standard from the search tree.

A solution search method according to the present invention includes a step of selecting a node to be simulated from among nodes as options in a search tree in solution search using simulation, and performing a simulation from the selected node, a step of calculating an evaluation value by use of an evaluation function based on a simulation result, and updating evaluation values of the selected node and its higher nodes based on the evaluation value, and a step of separating a node with an evaluation value which does not meet a predefined standard from the search tree.

A solution search program according to the present invention which causes a computer to perform: a processing of selecting a node to be simulated from among nodes as options in a search tree in solution search using simulation, and performing a simulation from the selected node; a processing of calculating an evaluation value by use of an evaluation function based on a simulation result, and updating evaluation values of the selected node and its higher nodes based on the evaluation value; and a processing of separating a node with an evaluation value which does not meet a predefined standard from the search tree.

### Advantageous Effects of Invention

According to the present invention, it is possible to accurately calculate a solution within a designated calculation time and to enhance an accuracy of solution without increasing the amount of memory use when solving an optimization problem or the like.

### BRIEF DESCRIPTION OF DRAWINGS

FIG. 1 It depicts a block diagram illustrating a structure of an optimization system according to a first exemplary embodiment.

FIG. 2 It depicts an explanatory diagram illustrating how pruning is performed on a search tree.

FIG. 3 It depicts a flowchart illustrating the operations of a calculation unit according to the first exemplary embodiment.

FIG. 4 It depicts a block diagram illustrating other structure of the optimization system according to the first exemplary embodiment.

FIG. 5 It depicts a block diagram illustrating an exemplary structure of the optimization system comprising an optimization device including two pruning units.

FIG. 6 It depicts a flowchart illustrating the operations of the calculation unit in the optimization device illustrated in FIG. 5.

FIG. 7 It depicts a block diagram illustrating a minimum structure of a solution search device according to the present invention.

### DESCRIPTION OF EMBODIMENTS

### First Exemplary Embodiment

A first exemplary embodiment according to the present invention will be described below with reference to the drawings.

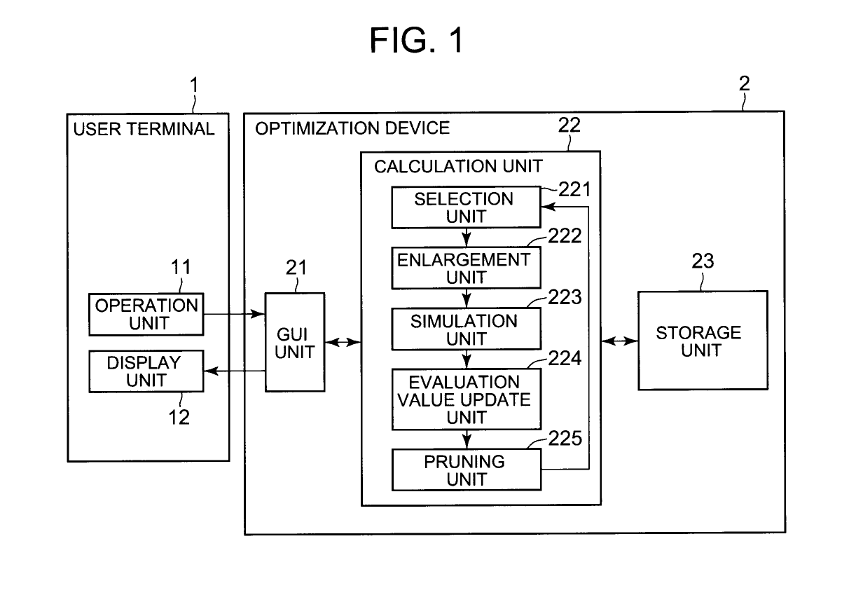

FIG. 1 is a block diagram illustrating a structure of an optimization system according to the first exemplary embodiment.

As illustrated in FIG. 1, the optimization system according to the first exemplary embodiment includes a user terminal 1 and an optimization device 2. The user terminal 1 and the optimization device 2 are communicably connected with each other. One user terminal is illustrated in FIG. 1 by way of example, but any number of user terminals may be connected to the optimization device 2.

The user terminal 1 is an information processing terminal such as a personal computer. The user terminal 1 includes an operation unit 11 and a display unit 12.

The operation unit 11 inputs information required for an optimization calculation to be made (which will be denoted as optimization calculation input information below). The operation unit 11 inputs an execution instruction. The operation unit 11 outputs an execution instruction to the optimization device 2 together with the optimization calculation input information.

The display unit 12 receives and displays the solution of an optimization calculation result from the optimization device 2.

The optimization device 2 includes a GUI (Graphical User Interface) unit 21, a calculation unit 22, and a storage unit 23.

The GUI unit 21 receives the optimization calculation input information from the operation unit 11 in the user terminal 1. The GUI unit 21 transmits the optimization calculation input information to the calculation unit 22. The GUI unit 21 receives the solution of an optimization calculation result from the calculation unit 22 and transmits it to the display unit 12 in the user terminal 1.

The calculation unit 22 includes a selection unit 221, an enlargement unit 222, a simulation unit 223, an evaluation value update unit 224, and a pruning unit 225.

The selection unit 221 selects a node to be subjected to playout from among developed nodes. In the following, a node to be subjected to playout will be called selected node.

The enlargement unit 222 enlarges a search tree. Specifically, the enlargement unit 222 determines whether a node selected by the selection unit 221 needs to be developed according to a predefined standard, and if necessary, develops the node to a next lowest level and enlarges the search tree. When developing the node, the enlargement unit 222 reselects the selected node to a node in the next lowest level.

The simulation unit 223 performs a simulation. Specifically, the simulation unit 223 searches one solution in a simple method such as playout or random simulation, and acquires an evaluation value of the solution.

The evaluation value update unit 224 updates the evaluation value of the solution of each node depending on a result of playout performed by the simulation unit 223. The evaluation values of the respective nodes are made of statistic values as a collection of evaluation values acquired by repeated simulations, and the evaluation value update unit 224 updates the statistic values.

The evaluation value update unit 224 calculates an index value. In the present exemplary embodiment, the evaluation function values (which will be also denoted as solution evaluation values below) of best, mean and kbest are calculated as index values, respectively.

The evaluation value update unit 224 calculates a comprehensive evaluation value in combination of the calculated evaluation values. At this time, the evaluation value update unit 224 calculates the comprehensive evaluation value in consideration of tradeoff of each index (best, mean, kbest) such that a characteristic value of each index is emphasized.

The evaluation value update unit 224 updates the evaluation value of each node based on a comprehensive evaluation value calculation result.

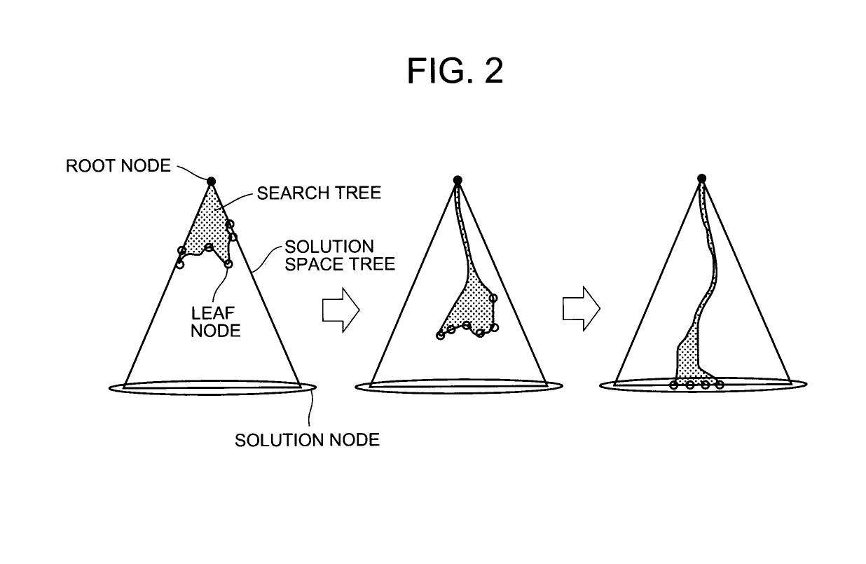

The pruning unit 225 performs pruning. FIG. 2 is an explanatory diagram illustrating how pruning is performed on a search tree. A triangle frame illustrated in FIG. 2 indicates a solution space tree. An oval surrounding the base of the triangle indicates the lowest node of the solution space tree, or a solution node. A dotted area indicates a search tree. A black circle indicates a root node of the search tree, or the uppermost node of the solution space tree. A white circle indicates a leaf node of the search tree. As illustrated in FIG. 2, according to the present exemplary embodiment, pruning is performed toward the lowest level of the solution space tree over time or along with a development of the search tree. The pruning unit 225 performs pruning such that the size of the search tree (the area of the dotted area illustrated in FIG. 2) does not exceed a certain size.

The storage unit 23 stores a target function or restriction condition. When the optimization system is applied to a scheduling problem, the storage unit 23 stores data required to solve the problem (which will be called problem data below), such as task information or person-in-charge information. Further, while a calculation processing advances in the calculation unit 22, the storage unit 23 stores changing information such as evaluation values of nodes. In the present exemplary embodiment, the storage unit 23 stores the number of times of node search or the evaluation values acquired in each calculation by the calculation unit 22. The storage unit 23 stores solutions required to be held among the solutions found by the calculation unit 22.

The GUI unit 21 and the calculation unit 22 are realized by a computer operating according to a solution search program, for example. In this case, the CPU provided in the optimization device 2 reads the solution search program and operates as the GUI unit 21 and the calculation unit 22 according to the program. Further, the GUI unit 21 and the calculation unit 22 may be realized in different hardware.

The storage unit 23 is realized by a storage device such as RAM (Random Access Memory) provided in the optimization device 2.

The operations according to the present exemplary embodiment will be described below.

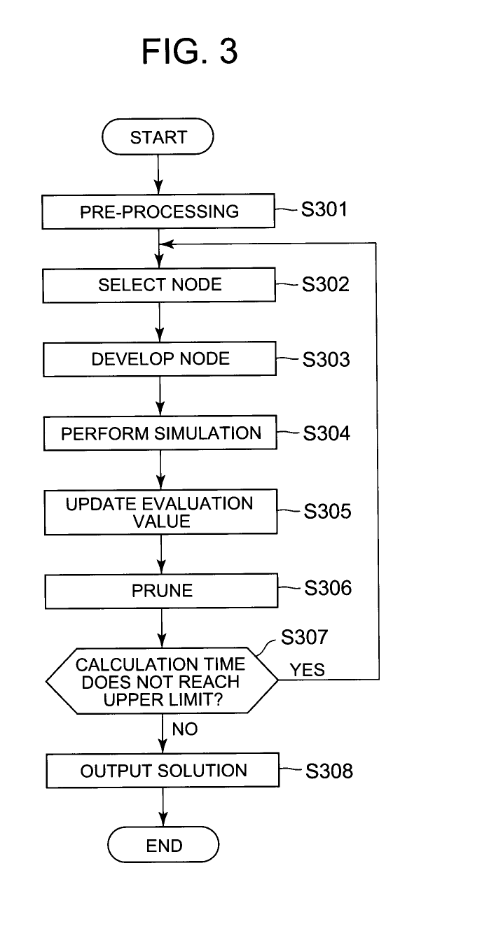

FIG. 3 is a flowchart illustrating the operations of the calculation unit 22 according to the first exemplary embodiment.

There will be described herein a case in which the optimization system illustrated in FIG. 1 is applied to a scheduling problem by way of example.

At first, the user inputs optimization calculation input information in the operation unit 11 in the user terminal 1. The user inputs, as the optimization calculation input information, problem data on task to be subjected to optimization calculation, possible person in charge, and cost or effectiveness when each person in charge engages in his/her task. At this time, the user inputs an execution instruction in the operation unit 11 together with the optimization calculation input information. The operation unit 11 outputs the optimization calculation input information and the execution instruction to the optimization device 2.

The GUI unit 21 in the optimization device 2 receives both of the optimization calculation input information and the execution instruction from the user terminal 1, and then transmits the optimization calculation input information to the calculation unit 22. The calculation unit 22 inputs the optimization calculation input information as a pre-processing (step S301).

After step S301, the selection unit 221 in the calculation unit 22 selects a node to be simulated from among the developed nodes (step S302). Only one node is present in the initial state, and thus the node is to be selected. A node is selected by use of an index value calculated by the evaluation value update unit 224 according to the present exemplary embodiment.

When the number of times of playout of the node selected by the selection unit 221 meets a predefined condition, the enlargement unit 222 develops the search tree to an one-level lower node (step S303). According to the present exemplary embodiment, the enlargement unit 222 develops when the number of times of playout exceeds the predefined number of times. When only one node is present in the initial state, the development is done irrespective of the condition. When the development is done, the enlargement unit 222 regards one of the developed nodes as a selected node.

The simulation unit 223 performs playout or random simulation from the selected node thereby to search a solution (step S304). A plurality of simulations may be performed on one selected node thereby to search a plurality of solutions, but there will be described herein, as a simple example, a method for performing one simulation on one selected node thereby to search a solution. The technical scope of the present invention is not limited to the form in which one simulation is performed on one selected node. Therefore, a form in which a plurality of simulations are performed on one selected node is also encompassed in the technical scope of the present invention.

The evaluation value update unit 224 updates the evaluation values of the solutions such as best, mean and kbest by use of the solutions acquired by the simulation unit 223. According to the present exemplary embodiment, the evaluation value update unit 224 updates an evaluation value of the solution of mean (step S305). An evaluation value of the solution of best is optimum in the results of the simulations performed from the selected node so far. An evaluation value of the solution of mean is an average of the results of the simulations performed from the selected node so far. An evaluation value of the solution of kbest is an average of the best k solutions in the results of the simulations performed from the selected node so far.

The evaluation value update unit 224 performs the following normalization processing on the evaluation value of the solution of mean as an index value.

When the index values of a selected node and its brother nodes (nodes having a common parent node with the selected node) are assumed as v₁, v₂, v₃, . . . , v_{L}, the maximum value M and the minimum value m can be expressed as follows. L indicates the total number of child nodes having a common parent node.

$$\begin{matrix}[ Mathematical Formula 1 ] & \\ M = {max}_{1 \leq i \leq L} {v}_{i} & ( Equation 1 )\end{matrix}$$

$$\begin{matrix}[ Mathematical Formula 2 ] & \\ m = {min}_{1 \leq i \leq L} {v}_{i} & ( Equation 1 )\end{matrix}$$

Herein, vᵢ is assumed to be determined as good to be close to the minimum value m according to a predefined standard. It is assumed to be determined as bad to be close to the maximum value M. The evaluation value update unit 224 normalizes Vᵢ in order to assume the minimum value m as a good value at 0 and the maximum value M as a bad value at 1. Specifically, the evaluation value update unit 224 converts vᵢ as follows. Valueᵢ is a normalized value vᵢ.

$$\begin{matrix}[ Mathematical Formula 3 ] & \\ {Value}_{i} = \{ \begin{matrix}\frac{{v}_{i} - m}{M - m} , & if M > m \\ 1 , & if M = m\end{matrix} & ( Equation 3 )\end{matrix}$$

Vᵢ may be further normalized such that a value of Valueᵢ is within a certain variance.

The evaluation value update unit 224 performs the above series of processings on mean so that Valueᵢ corresponding to mean is calculated. In the following, Valueᵢ corresponding to best, mean and kbest are expressed as bestValue, meanValue and kbestValue(K), respectively. “(k)” indicates that the highest k solutions are to be subjected to average calculation.

The evaluation value update unit 224 calculates meanValue by a selected node and its higher nodes, respectively, and updates the evaluation values of the respective nodes based on the calculation results.

When determining that a size of the search tree, for example, the number of nodes in the entire search tree or the number of leaf nodes in the search tree is large and pruning is required, the pruning unit 225 performs pruning. When it is determined that a space to be searched needs to be narrowed in order to cause the search tree to reach the bottom of the solution space tree within a given designated time, pruning is performed (step S306). According to the present embodiment, the pruning unit 225 evaluates each node by mean updated by the evaluation value update unit 224 in step S305, and prunes a node with a bad evaluation value from the search tree. Thereafter, simulation is not performed from the node and its lower nodes.

A method for performing pruning for causing the search tree to reach the bottom of the solution space tree within a designated time in step S306 employs a method for adjusting an interval at which pruning is performed in each level. When the depth levels of the entire solution space tree range from the first level to the bottom (N-th level), the center of the search tree moves toward the bottom as the calculation time elapses. The pruning unit 225 performs pruning for restricting the number of nodes positioned at a depth of the n-th level when n/N of the entire calculation time elapses. For example, at N=10, pruning for restricting the number of nodes positioned at a depth of the sixth level is performed when 60% of the permitted calculated time elapses. Thereby, the search tree can reach the bottom of the solution space tree within the calculation time. The intervals at which pruning is performed on each level may not be uniform. For example, pruning for restricting the number of nodes positioned at a depth of the n-th level may be performed when √(n/N) of the entire calculation time elapses. Thereby, more calculation time can be allocated to a node near the root node requiring more calculation time.

The calculation unit 22 repeatedly performs the processing in step S302 to S306 (the selection processing, the node development processing, the simulation processing, the evaluation value update processing and the pruning processing) until the calculation time in the calculation unit 22 reaches the predefined upper limit. That is, when the calculation time does not reach the upper limit (Yes in step S307), the calculation unit 22 returns to the processing in step S302. When the calculation time reaches the upper limit (No in step S307), the calculation unit 22 terminates the calculation, and passes the optimization calculation result or solution information on a searched solution to the GUI unit 21 (step S308). The calculation unit 22 may repeatedly perform the series of processings in step S302 to S306 until a value of the solution given as a requirement is calculated.

In the series of calculation processings in step S302 to S306, the calculation unit 22 stores information including the number of times of node search or the evaluation values acquired in each calculation in the storage unit 23. The calculation unit 22 stores information including a searched solution in the storage unit 23. The calculation unit 22 acquires the information stored in the storage unit 23 thereby to recognize the number of times of node search or the evaluation values during the calculation.

The present exemplary embodiment assumes the case in which problem data is input as the optimization calculation input information from the user terminal 1 into the calculation unit 22, but the calculation unit 22 may acquire the problem data stored in the storage unit 23. In order to realize such a form, the user or the like may previously store the problem data in the storage unit 23.

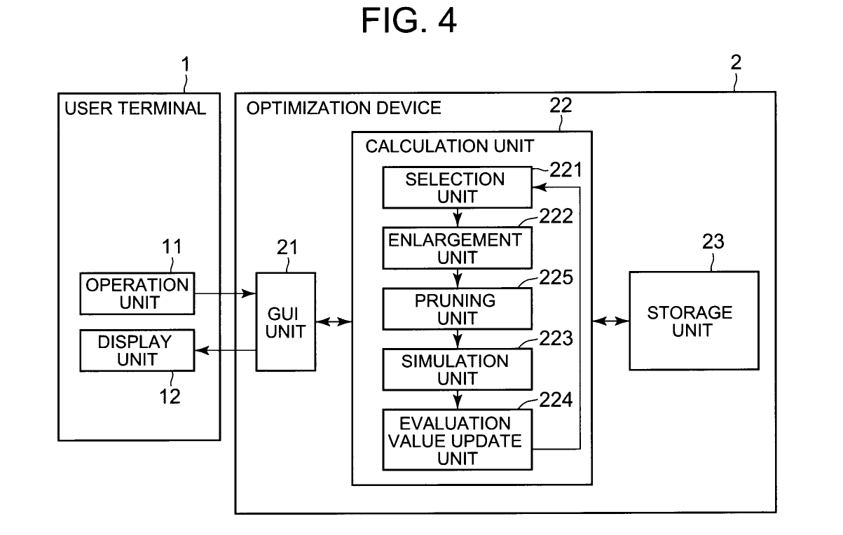

A timing when the pruning processing in step S306 is performed is not limited to after the evaluation value update processing in step S305. For example, as illustrated in FIG. 4, the pruning unit 225 may be arranged between the enlargement unit 222 and the simulation unit 223. That is, the pruning processing in step S306 may be performed between the processing in step S303 and the processing in step S304. FIG. 4 is a block diagram illustrating other structure of the optimization system according to the first exemplary embodiment.

As described above, according to the present exemplary embodiment, pruning is performed by use of a simulation result in MCTS thereby to appropriately narrow a search range. Thereby, the search tree can reach the bottom of the solution space tree within a given calculation time thereby to accurately calculate a solution without increasing the amount of memory use. The number of times of simulation of a node determined as important based on a simulation result can be increased. Thereby, a possibility of improving the accuracy of solution in the search method for calculating an evaluation value by simulation such as MCTS can be enhanced. Further, the accuracy of solution is improved, thereby enhancing the practical possibility of OR which is difficult to put into practical use.

### Second Exemplary Embodiment

A second exemplary embodiment according to the present invention will be described below.

A structure of the optimization system according to the second exemplary embodiment is similar to the structure of the first exemplary embodiment.

There will be described herein by way of example the case in which the optimization system is applied to a scheduling problem as in the first exemplary embodiment.

The operations of the calculation unit 22 according to the second exemplary embodiment are similar to the operations according to the first exemplary embodiment illustrated in FIG. 3.

However, the operation of the selection unit 221 in step S302, the operation of the evaluation value update unit 224 in step S305, and the operation of the pruning unit 225 in step S306 are different. The operations in step S302, step S305 and step S306 will be described herein.

When selecting a node in step S302, the selection unit 221 employs a different index value from an index value used for determining whether the pruning unit 225 performs pruning. According to the present exemplary embodiment, an index used for selecting a node is assumed as mean and an index used for pruning is assumed as best. That is, an index value used for selecting a node is assumed as meanValue and an index value used for pruning is assumed as bestValue.

In step S305, the evaluation value update unit 224 calculates meanValue and bestValue by use of Equation 1 to Equation 3. At this time, the evaluation value update unit 224 calculates meanValue and bestValue by a selected node and its higher nodes, respectively, and updates the evaluation values of the respective nodes based on the calculation results.

In step S306, the pruning unit 225 evaluates each node by the index best different from the index used by the selection unit 221 for selecting a node, and performs the pruning processing.

In this way, according to the present exemplary embodiment, each node in the search tree has both of the evaluation value meanValue for selecting a node and the evaluation value bestValue for pruning. Specifically, the evaluation value update unit 224 stores meanValue and bestValue in the storage unit 23 in association with each node in the search tree.

The evaluation value meanValue for node selection may be held in an edge (branch) connecting a node and its parent, and the evaluation value bestValue for pruning may be held in a node.

As described above, the present exemplary embodiment can obtain similar effects to those of the first exemplary embodiment, and a different evaluation function from the one for node selection can be set for an index for pruning. Thereby, a less valuable node can be more appropriately selected and removed in pruning. For example, it is assumed that in pruning, a node presenting an optimum result (bestValue) should not be removed even if its average (meanValue) is low. According to the present exemplary embodiment, it is possible to prevent such a node from being removed.

In this way, a less valuable node is more appropriately removed thereby increasing the number of times of simulation of a more valuable node in the executable memory space. If the number of times of simulation of a more important node can be more appropriately increased, a possibility of further improving the accuracy of solution in the search method for calculating an evaluation value by simulation such as MCTS can be enhanced.

### Third Exemplary Embodiment

A third exemplary embodiment according to the present invention will be described below.

A structure of the optimization system according to the third exemplary embodiment is similar to the structure of the first exemplary embodiment.

However, the evaluation value update unit 224 in the optimization device 2 calculates a comprehensive evaluation value of a node based on the index values bestValue, meanValue and kbestValue. The evaluation value update unit 224 in the optimization device 2 then updates the evaluation value of each node based on the calculated comprehensive evaluation value of the node.

There will be assumed herein by way of example the case in which the optimization system is applied to a scheduling problem as in the first exemplary embodiment.

The operations of the calculation unit 22 according to the third exemplary embodiment are similar to the operations according to the first exemplary embodiment illustrated in FIG. 3.

However, the operation of the evaluation value update unit 224 in step S305 is different. The operation of the evaluation value update unit 224 in step S305 will be described herein.

The evaluation value update unit 224 calculates meanValue, bestValue and kbestValue(k) by use of Equation 1 to Equation 3 after step S304.

The evaluation value update unit 224 acquires a comprehensive evaluation value of a node by use of the following calculation equation per node. hValue is a comprehensive evaluation value of a node. w and ε are the coefficients indicating the weights of the indexes best, mean and kbest.

$$hValue ( bestValue , meanValue , kbestvalue ( k ) ) = \frac{\begin{matrix}\begin{matrix}{w}_{best} ( \frac{1}{1 + {ɛ}_{best}} ) + \\ {w}_{kbest ( k )} ( \frac{1}{1 + {ɛ}_{kbest} ( k )} ) +\end{matrix} \\ {w}_{mean} ( \frac{1}{1 + {ɛ}_{mean}} )\end{matrix}}{\begin{matrix}\begin{matrix}{w}_{best} ( \frac{1}{bestValue + {ɛ}_{best}} ) + \\ {w}_{kbest ( k )} ( \frac{1}{kbestValue ( k ) + {ɛ}_{kbest ( k )}} ) +\end{matrix} \\ {w}_{mean} ( \frac{1}{meanValue + {ɛ}_{mean}} )\end{matrix}} \qquad [ Mathematical Formula 4 ]$$

For example, when w_{best}, wₘₑₐₙ, and w_{kbest(k)} are increased, a degree of impact of each index on the entire Equation, or a degree of impact of each index on hValue can be strengthened.

ε_{best}, εₘₑₐₙ, and ε_{kbest(k)} are the coefficients for adjusting a degree of impact of each index when bestValue, meanValue and kbestValue(k) are the best or around zero. When a degree of impact of each index is desired to be strengthened, the values of ε_{best}, εₘₑₐₙ, and ε_{kbest(k)} are decreased or are approached to zero. For example, when bestValue is around zero, the term of the denominator best is “w_{best}×100” at ε_{best}=0.01. The term of the denominator best is “w_{best}×10” at ε_{best}=0.1. In this way, as ε_{best} is smaller when bestValue is around zero, the degree of impact of the index best is higher. ε is adjusted so that a speed to cause a comprehensive evaluation value hValue to reach the best value of zero can be adjusted when bestValue, meanValue and kbestValue(k) are good values.

In this way, the values of w and ε are used thereby to consider tradeoff of each index. An evaluation value of a node good for a specific index can be enhanced. w and ε are previously stored in the storage unit 23 in the optimization device 2.

The evaluation value update unit 224 discriminates the values of w and ε between the evaluation function used for node selection and the evaluation function used for pruning. For example, the evaluation function used for node selection is as follows:

w_{best}=1.1,ε_{best}=0.1

w_{kbest(k)}=0.2,ε_{kbest(k)}=0.04

wₘₑₐₙ=0.7,εₘₑₐₙ=0.01 [Mathematical Formula 5]

The evaluation function used for pruning is as follows:

w_{best}=0.5,ε_{best}=0.001

w_{kbest(k)}=0.3,ε_{kbest(k)}=0.01

wₘₑₐₙ=0.2,εₘₑₐₙ=0.1 [Mathematical Formula 6]

The evaluation value update unit 224 calculates the evaluation function value used for node selection and the evaluation function value used for pruning by the selected node and its higher nodes, respectively, and updates the evaluation values of the respective nodes based on the calculation results.

As described above, the present exemplary embodiment can obtain similar effects to those in the second exemplary embodiment.

### Fourth Exemplary Embodiment

A fourth exemplary embodiment according to the present invention will be described below.

A structure of the optimization system according to the fourth exemplary embodiment is similar to the structure of the first exemplary embodiment.

However, the evaluation value update unit 224 in the optimization device 2 calculates a comprehensive evaluation value of a node based on each index value bestValue, meanValue or kbestValue similarly to the third exemplary embodiment. At this time, the evaluation value update unit 224 calculates a comprehensive evaluation value of a node per depth level of the search tree. The solution space tree is assumed to have N levels. That is, the solution space tree is assumed to have a depth of N levels.

There will be described herein by way of example the case in which the optimization system is applied to a scheduling problem as in the first exemplary embodiment.

The operations of the calculation unit 22 according to the fourth exemplary embodiment are similar to the operations according to the third exemplary embodiment.

However, the operation of the evaluation value update unit 224 in step S305 is different. The operation of the evaluation value update unit 224 in step S305 will be described herein.

The evaluation value update unit 224 calculates meanValue, bestValue and kbestValue(k) by use of Equation 1 to Equation 3 after step S304.

The evaluation value update unit 224 acquires a comprehensive evaluation value of a node by use of the following calculation equation per node. w_{best}(n), wₘₑₐₙ(n), w_{kbest(k)}(n), ε_{best}(n), εₘₑₐₙ(n), and β_{kbest(k)}(n) are the coefficients expressing a weight on each index best, mean or kbest at the n-th level, respectively, when the solution space tree is assumed to have N levels.

$$hValue ( bestValue , meanValue , kbestvalue ( k ) ) = \frac{\begin{matrix}\begin{matrix}{w}_{best} ( n ) ( \frac{1}{1 + {ɛ}_{best} ( n )} ) + \\ {w}_{kbest ( k )} ( n ) ( \frac{1}{1 + {ɛ}_{kbest} ( n )} ) +\end{matrix} \\ {w}_{mean} ( n ) ( \frac{1}{1 + {ɛ}_{mean} ( n )} )\end{matrix}}{\begin{matrix}\begin{matrix}{w}_{best} ( n ) ( \frac{1}{bestValue + {ɛ}_{best} ( n )} ) + \\ {w}_{kbest ( k )} ( n ) ( \frac{1}{kbestValue ( k ) + {ɛ}_{kbest ( k )} ( n )} ) +\end{matrix} \\ {w}_{mean} ( n ) ( \frac{1}{meanValue + {ɛ}_{mean} ( n )} )\end{matrix}} \qquad [ Mathematical Formula 7 ]$$

Further, the evaluation value update unit 224 discriminates the values of w and ε between the evaluation function used for node selection and the evaluation function used for pruning as follows. For example, the evaluation function used for node selection is as follows:

$${w}_{best} ( n ) = \frac{n}{N} \\ {w}_{kbest ( k )} ( n ) = min ( \frac{n}{N} , 1 - \frac{n}{N} ) \\ {w}_{mean} ( n ) = max ( 1 - \frac{2 n}{N} , 0 ) \qquad [ Mathematical Formula 8 ]$$

The evaluation function used for pruning is as follows:

$${w}_{best} ( n ) = 0.9 \frac{n}{N} \\ {w}_{kbest ( k )} ( n ) = 0.9 ( 1 - \frac{n}{N} ) \\ {w}_{mean} ( n ) = 0.1 \qquad [ Mathematical Formula 9 ]$$

As described above, the present exemplary embodiment can obtain similar effects to those of the third exemplary embodiment, and the evaluation functions can be changed depending on a depth of each node in the search tree. Thereby, the number of times of simulation of a node can be appropriately increased. Thus, the number of times of simulation of a more important node can be appropriately increased, thereby enhancing a possibility of further improving the accuracy of solution in the search method for calculating an evaluation value by simulation such as MCTS.

### Fifth Exemplary Embodiment

A fifth exemplary embodiment according to the present invention will be described below with reference to the drawings.

A structure of the optimization system according to the fifth exemplary embodiment is similar to the structure of the first exemplary embodiment.

However, the evaluation value update unit 224 in the optimization device 2 discriminates the evaluation functions used for pruning between the evaluation function used for pruning directed to restrict a size of the solution space tree and the evaluation function used for pruning directed to cause the search tree to reach the bottom of the solution space tree within a designated calculation time, and sets them per node. In the present exemplary embodiment, the evaluation function used for pruning is assumed as mean, the evaluation function used for pruning directed to restrict a size of the solution space tree is assumed as kbest, and the evaluation function used for pruning directed to cause the search tree to reach the bottom of the solution space tree within a designated calculation time is assumed as best.

The operations of the calculation unit 22 according to the fifth exemplary embodiment are similar to the operations according to the first exemplary embodiment illustrated in FIG. 3.

However, the operations of the evaluation value update unit 224 in step S305 and the pruning unit 225 in step S306 are different. The operations in step S305 and step S306 will be described herein.

In step S305, the evaluation value update unit 224 calculates meanValue, bestValue, kbestValue(k) by use of Equation 1 to Equation 3.

The evaluation value update unit 224 calculates meanValue, kbestValue(k), and bestValue by a selected node and its higher nodes, respectively, and updates the evaluation values of the respective nodes based on the calculation results.

meanValue is used for the node selection processing in the selection unit 221. kbestValue(k) is used for the pruning processing directed to restrict a size of the search tree in the pruning unit 225. bestValue is used for the pruning processing directed to cause the search tree to reach the bottom of the solution space tree within a designated calculation time in the pruning unit 225.

In step S306, the pruning unit 225 evaluates each node by the evaluation function kbestValue(k) or bestValue different from the evaluation function used by the selection unit 221 for selecting a node, and performs the pruning processing. At this time, the pruning unit 225 determines which of kbestValue(k) and bestValue to use depending to a purpose of the pruning processing to be performed. That is, it is determined depending on whether the pruning processing is directed to restrict a size of the search tree or directed to cause the search tree to reach the bottom of the solution space tree within a designated calculation time.

As described above, the present exemplary embodiment can obtain similar effects to those of the second exemplary embodiment, and the evaluation functions used for pruning can be set for a purpose of the pruning. Thereby, a less valuable node can be more appropriately selected and removed depending on a purpose of the pruning. For example, in the pruning directed to restrict a size of the search tree, a value close to an average expectation (mean) is left thereby to reduce a risk of a big error in the pruning at a small number of times of simulation. The pruning directed to cause the search tree to reach the bottom of the solution space tree within a calculation time is performed after a certain number of times of simulation at each node, and the risk may be remarkably reduced even with best. Thus, a less valuable node can be more appropriately and more efficiently removed. Therefore, the number of times of simulation of a more valuable node can be increased in the executable memory space.

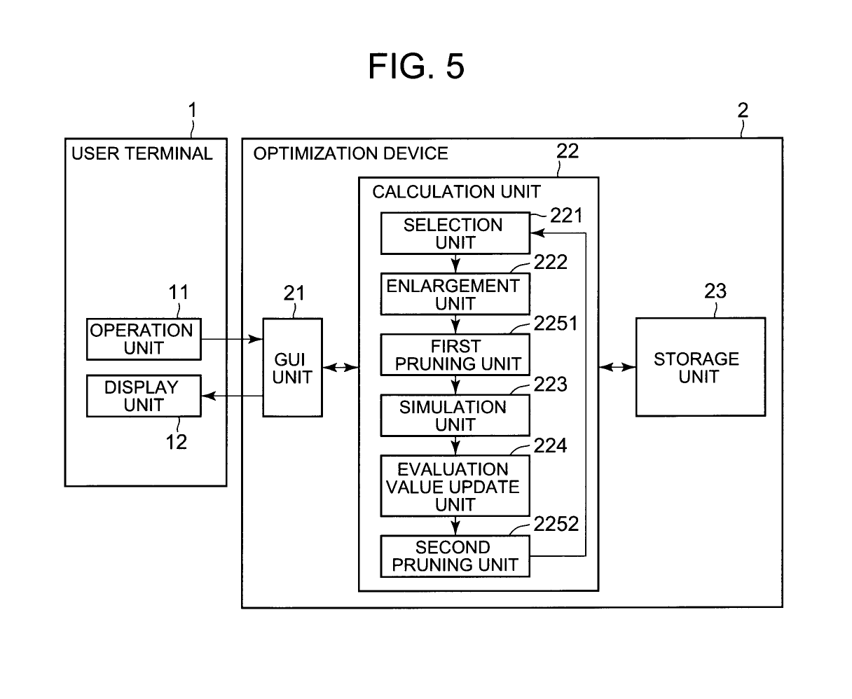

The calculation unit includes one pruning unit according to the fifth exemplary embodiment by way of example, but as illustrated in FIG. 5, the calculation unit 22 may include a first pruning unit 2251 for performing a pruning processing directed to restrict a size of the search tree and a second pruning unit 2252 for performing a pruning processing directed to cause the search tree to reach the bottom of the solution space tree within a designated calculation time. FIG. 5 is a block diagram illustrating an exemplary structure of the optimization system provided with the optimization device including two pruning units.

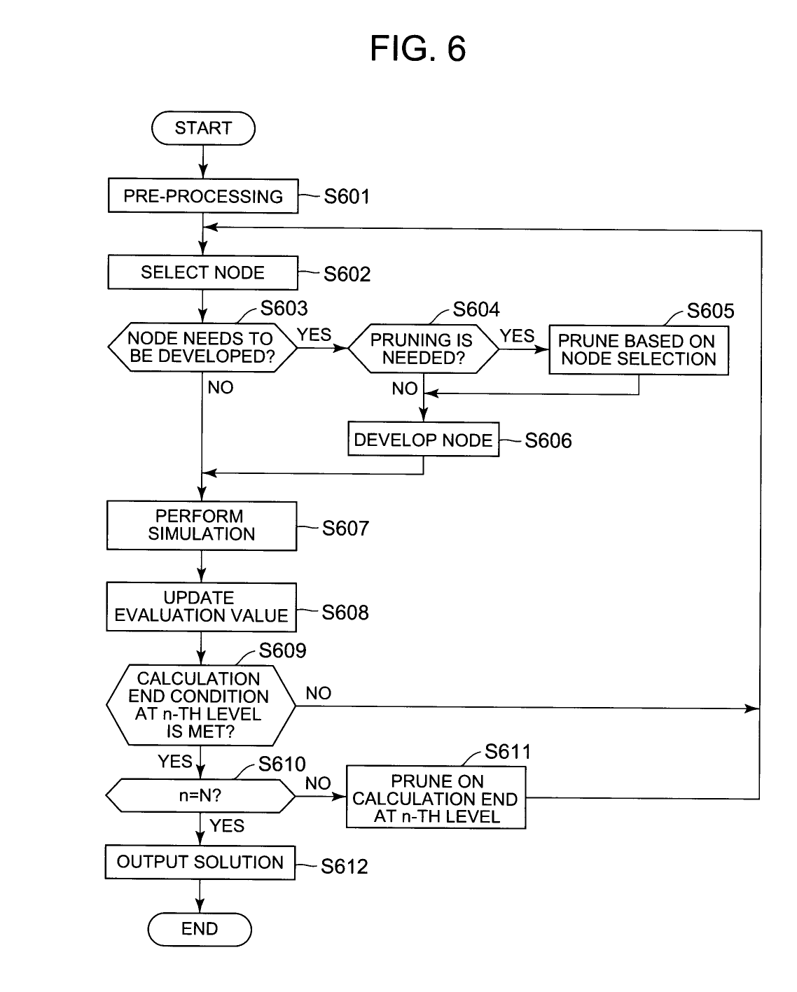

FIG. 6 is a flowchart illustrating the operations of the calculation unit in the optimization device illustrated in FIG. 5.

The series of processings in step S601, step S602, steps S606 to S608, and step S612 are similar to the series of processings in step S301, step S302, steps S303 to S305, and step S308, and thus the description thereof will be omitted.

When the number of times of playout of a node selected by the selection unit 221 meets a predefined condition (Yes in step S603), the first pruning unit 2251 determines whether a size of the search tree needs to be restricted by pruning (step S604). When pruning is required (Yes in step S604), the first pruning unit 2251 performs pruning (step S605). When pruning is not required (No in step S604), the enlargement unit 222 develops the search tree to an one-level lower node.

The calculation unit 22 repeatedly performs the series of processings in step S602 to S608 until a calculation time at the n-th level meets the predefined end condition (step S609). When the calculation time meets the predefined end condition (Yes in step S609), the calculation unit 22 confirms whether the search tree reaches the bottom of the solution space tree (N-th level) (step S610). When the search tree does not reach the bottom of the solution space tree (No in step S610), the second pruning unit 2252 performs pruning (step S611). The calculation unit 22 performs the processing in step S611 and then returns to the processing in step S602. When the search tree reaches the bottom of the solution space tree (Yes in step S610), the processing proceeds to step S612.

There has been described above in each exemplary embodiment the case in which the optimization device is applied to a scheduling problem, but the applicable scope of the present invention is not limited thereto. The present invention can be applied to general optimization problems centered on combination optimization problems such as scheduling problem for allocating tasks to persons in charge. It can be applied also to solution search other than optimization problems.

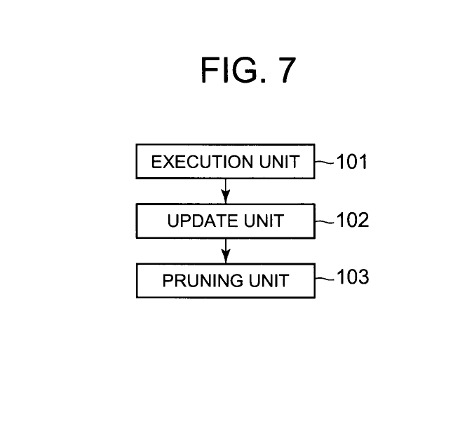

FIG. 7 is a block diagram illustrating a minimum structure of a solution search device according to the present invention. As illustrated in FIG. 7, the solution search device (corresponding to the optimization device 2 illustrated in FIG. 1) includes an execution unit 101 (corresponding to the selection unit 221, the enlargement unit 222 and the simulation unit 223 in the optimization device 2 illustrated in FIG. 1) for selecting a node to be simulated from among nodes as options in a search tree in solution search using simulation, and performing a simulation from the selected node, an update unit 102 (corresponding to the evaluation value update unit 224 in the optimization device 2 illustrated in FIG. 1) for calculating an evaluation value by use of an evaluation function based on a simulation result, and updating the evaluation values of the selected node and its higher nodes based on the evaluation value, and a pruning unit 103 (corresponding to the pruning unit 225 in the optimization device 2 illustrated in FIG. 1) for separating a node with an evaluation value which does not meet a predefined standard from the search tree.

With the structure, pruning is performed by use of a simulation result in MCTS, thereby appropriately narrowing a search range. Thereby, the search tree can be caused to reach the bottom of the solution space tree within a given calculation time thereby to accurately calculate a solution without increasing the amount of memory use. The number of times of simulation of a node determined as important based on the simulation result can be increased. Therefore, a possibility of improving the accuracy of solution in the search method for calculating an evaluation value by simulation such as MCTS can be enhanced.

The following solution search devices are also disclosed in the above exemplary embodiments.

(1) The solution search device in which the pruning unit 103 performs the series of processings of determining a time interval to perform pruning based on a designated calculation time, and separating a node with an evaluation value which does not meet a predefined standard from the search tree based on the time interval.

With the structure, the search tree can be caused to accurately reach the bottom of the solution space tree within a given calculation time.

(2) The solution search device in which the pruning unit 103 gradually shortens the time interval to perform pruning as a solution search time elapses.

With the structure, more calculation time can be allocated to a node near the root requiring more calculation time.

(3) The solution search device in which when a size of the search tree exceeds a certain size, the pruning unit 103 separates a node with an evaluation value which does not meet a predefined standard from the search tree.

With the structure, the size of the search tree can be accurately restricted to a certain size or less.

(4) The solution search device in which the pruning unit 103 uses different evaluation values between pruning based on a time interval and pruning based on a size of the search tree.

With the structure, a less valuable node is more appropriately selected and removed according to a purpose of pruning. Thus, a less valuable node can be more appropriately and more efficiently removed in the pruning.

(5) The solution search device in which the pruning unit 103 determines whether to separate a node from the search tree based on a different evaluation value from an evaluation value used by the execution unit 101 for selecting a node.

With the structure, a less valuable node can be appropriately selected and removed in the pruning.

(6) The solution search device in which the update unit 102 calculates evaluation values for a plurality of evaluation functions by use of the plurality of evaluation functions based on a simulation result, and calculates a harmonic mean of the calculated evaluation values as a comprehensive evaluation value, and updates the evaluation values of the selected node and its higher nodes based on the comprehensive evaluation value, and the pruning unit 103 determines whether to separate a node from the search tree based on the comprehensive evaluation value.

With the structure, a weight coefficient on each evaluation value of the harmonic mean is discriminated between an evaluation function used for node selection and an evaluation function used for pruning, thereby more appropriately selecting and removing a less valuable node in the pruning.

(7) The solution search device in which the update unit 102 changes a weight coefficient on each evaluation value when calculating a harmonic mean depending on a depth of the search tree.

With the structure, an evaluation function can be changed at a depth of each node in the search tree. Thereby, the number of times of simulation of a node can be appropriately increased.

Some or all of the above exemplary embodiments may be described as in the following Notes, but are not limited thereto.

(Supplementary note 1) A solution search device comprising an execution unit 101 for selecting a node to be simulated from among nodes as options in a search tree in solution search using simulation, and performing a simulation from the selected node, an update unit 102 for calculating an evaluation value by use of an evaluation function based on a simulation result, and updating evaluation values of the selected node and its higher nodes based on the evaluation value, and a pruning unit 103 for separating a node with an evaluation value which does not meet a predefined standard from the search tree based on the time interval.

(Supplementary note 2) The solution search device according to supplementary note 1, wherein the pruning unit 103 performs the series of processings of determining a time interval to perform pruning based on a designated calculation time, and separating a node with an evaluation value which does not meet a predefined standard from the search tree.

(Supplementary note 3) The solution search device according to supplementary note 2, wherein the pruning unit 103 gradually shortens the time interval to perform pruning as a solution search time elapses.

(Supplementary note 4) The solution search device according to any one of supplementary note 1 to supplementary note 3, wherein when a size of the search tree exceeds a certain size, the pruning unit 103 separates a node with an evaluation value which does not meet a predefined standard from the search tree.

(Supplementary note 5) The solution search device according to supplementary note 4, wherein the pruning unit 103 uses different evaluation values between pruning based on a time interval and pruning based on a size of the search tree.

(Supplementary note 6) The solution search device according to any one of supplementary note 1 to supplementary note 5, wherein the pruning unit 103 determines whether to separate a node from the search tree based on a different evaluation value from an evaluation value used by the execution unit 101 for selecting a node.

(Supplementary note 7) The search solution device according to supplementary note 6, wherein the update unit 102 calculates an evaluation value per evaluation function by use of an evaluation function for selecting a node and an evaluation function for separating a node from the search tree, which are allocated to each node, based on the simulation result.

With the structure, a less valuable node can be more appropriately selected and removed in the pruning.

(Supplementary Note 8)

The search solution device according to supplementary note 6, wherein the update unit 102 calculates an evaluation value per evaluation function by use of an evaluation function for selecting a node allocated to each edge and an evaluation function for separating a node from the search tree allocated to each node based on the simulation result.

With the structure, an evaluation function can be allocated to an edge, and the present invention can be applied to not only a tree but also a directed acyclic graph (DAG), for example.

(Supplementary note 9) The solution search device according to any one of supplementary note 1 to supplementary note 8, wherein the update unit 102 calculates evaluation values for a plurality of evaluation functions by use of the plurality of evaluation functions based on the simulation result, and calculates a harmonic mean of the calculated evaluation values as a comprehensive evaluation value, and updates the evaluation values of the selected node and its higher nodes based on the comprehensive evaluation value, and the pruning unit 103 determines whether to separate a node from the search tree based on the comprehensive evaluation value.

(Supplementary note 10) The solution search device according to supplementary note 9, wherein the update unit 102 changes a weight coefficient on each evaluation value when calculating a harmonic mean depending on a depth of the search tree.

The present application claims the priority based on Japanese Patent Application No. 2013-011628 filed on Jan. 25, 2013, the disclosure of which is all incorporated herein by its reference.

The present invention is described above with reference to the exemplary embodiments, but the present invention is not limited to the above exemplary embodiments. The structure and details of the present invention may be variously changed within the scope of the present invention understandable by those skilled in the art.

### REFERENCE SIGNS LIST

1 User terminal
2 Optimization device
11 Operation unit
12 Display unit
21 GUI unit
22 Calculation unit
23 Storage unit
101 Execution unit
102 Update unit
103, 225 Pruning unit
221 Selection unit
222 Enlargement unit
223 Simulation unit
224 Evaluation value update unit
2251 First pruning unit
2252 Second pruning unit

What is claimed is:

1. A solution search device comprising:
an execution unit for selecting a node to be simulated from among nodes as options in a search tree in solution search using simulation, and performing a simulation from the selected node;
an update unit for calculating an evaluation value by use of an evaluation function based on a simulation result, and updating evaluation values of the selected node and its higher nodes based on the evaluation value; and
a pruning unit for separating a node with an evaluation value which does not meet a predefined standard from the search tree.

2. The solution search device according to claim 1,
wherein the pruning unit performs the series of processings of determining a time interval to perform pruning based on a designated calculation time, and separating a node with an evaluation value which does not meet a predefined standard from the search tree based on the time interval.

3. The solution search device according to claim 2,
wherein the pruning unit gradually shortens the time interval to perform pruning as a solution search time elapses.

4. The solution search device according to claim 1,
wherein when a size of the search tree exceeds a certain size, the pruning unit separates a node with an evaluation value which does not meet a predefined standard from the search tree.

5. The solution search device according to claim 4,
wherein the pruning unit uses different evaluation values between pruning based on a time interval and pruning based on a size of the search tree.

6. The solution search device according to claim 1,
wherein the pruning unit determines whether to separate a node from the search tree based on a different evaluation value from an evaluation value used by the execution unit for selecting a node.

7. The solution search device according to claim 1,
wherein the update unit calculates evaluation values for a plurality of evaluation functions by use of the plurality of evaluation functions based on the simulation result, and calculates a harmonic mean of the calculated evaluation values as a comprehensive evaluation value, and updates the evaluation values of the selected node and its higher nodes based on the comprehensive evaluation value, and
the pruning unit determines whether to separate a node from the search tree based on the comprehensive evaluation value.

8. The solution search device according to claim 7,
wherein the update unit changes a weight coefficient on each evaluation value when calculating a harmonic mean depending on a depth of the search tree.

9. A solution search method comprising the steps of:
selecting a node to be simulated from among nodes as options in a search tree in solution search using simulation, and performing a simulation from the selected node;
calculating an evaluation value by use of an evaluation function based on a simulation result, and updating evaluation values of the selected node and its higher nodes based on the evaluation value; and
separating a node with an evaluation value which does not meet a predefined standard from the search tree.

10. A non-transitory computer-readable recording medium in which a solution search program is recorded, the solution search program causing a computer to perform:
a processing of selecting a node to be simulated from among nodes as options in a search tree in solution search using simulation, and performing a simulation from the selected node;
a processing of calculating an evaluation value by use of an evaluation function based on a simulation result, and updating evaluation values of the selected node and its higher nodes based on the evaluation value; and
a processing of separating a node with an evaluation value which does not meet a predefined standard from the search tree.
